(19) United States
(12) Patent Application Publication
(10) Pub. No.: US 2009/0091325 A1
(43) Pub. Date: Apr. 9, 2009

(54) METHOD OF DETERMINING DAMAGE TO SKIN

(75) Inventor: Rachel Mary Haywood, Middlesex (GB)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: UCL BUSINESS PLC, London (GB)

(21) Appl. No.: 12/067,161

(22) PCT Filed: Sep. 15, 2006
(86) PCT No.: PCT/GB06/03442

§ 371 Date: Nov. 7, 2008

(30) Foreign Application Priority Data
Sep. 15, 2005 (GB) 0518890.9

(51) Int. Cl. G01V 3/00

(52) U.S. Cl. 324/316

(57) ABSTRACT

The invention provides a method for determining the presence of high molecular weight molecules, aminoacid molecules or protein fragments, in human or other mammalian skin, comprising irradiating a sample of the said skin with light at one or more wavelengths present in solar radiation, in the presence of a spin-trapping agent for radicals of said molecules, and using comparative electron spin resonance (ESR) spectroscopy to determine or investigate the presence of radicals of the said molecules induced in the skin by the light. The method may be used to investigate a range of skin and other tissue damage and the efficacy of agents and methods intended to protect skin from damage.

### FIELD OF THE INVENTION

The present invention relates to a method of determining the presence of certain molecules in human or animal skin, particularly human or other mammalian skin. The molecules can be markers of structural damage, ageing and certain other skin conditions, diseases and disorders, for example skin cancers such as melanomas. The invention also relates to uses of such a method, particularly but not exclusively in determining whether the skin has suffered, or is susceptible to, structural damage, in the testing and evaluation of sunscreens and anti-ageing and other skin preparations, in the testing and evaluation of fabrics, for example in relation to their sun screening effectiveness, in research into the ageing of skin and into certain skin conditions, diseases and disorders, and in the diagnosis of, and prediction of susceptibility to, certain skin conditions, diseases and disorders, including investigating the relative susceptibility of different racial groups to structural skin damage and to skin cancers.

### BACKGROUND OF THE INVENTION

The physiological effect of ultra-violet A light radiation (UVA) is the initiation of radical reactions in skin and oxidative stress, nuclear p53 production and DNA damage [Scharfettner-Kochanek, K., Wlaschek, M., Brenneisen, P., Schauen, M., Blaudschun, R., and Wenk, J.: UV-induced reactive oxygen species in photocarcinogenesis and photoageing. Biol Chem 378: 1247-1257, 1997; Burren, R., Scaletta, C., Frenk, E., Panizzon, R. G., Applegate, L. A., Sunlight and carcinogenesis: expression of p53 and pyrimidine dimers in human skin following UVA I, +II and solar simulating radiations. Int J Cancer 76: 201-206, 1998], genomic instability [Phillipson, R. P., Tobi, S. E., Morris, J. A., McMillan, T. J.: UV-A induces persistent genomic instability in human keratinocytes through an oxidative stress mechanism. Free Rad Biol Med 32: 474-480, 2002] and immunosupression [Dumay, O., Karam, A., Vian, L., Moyal, D., Hourseau, C., Stoebner, P., Peyron, J. L., Meynadier, J., Cano, J. P., Meunier, L.: Ultra-violet AI exposure of human skin results in Langerhans cell depletion and reduction of epidermal antigen-presenting cell function: partial protection by a broad spectrum sunscreen. Br J Dermatol 144:1161-8, 2001]. The blue component of visible light is strongly implicated in retinal damage from photosensitised oxygen radical production via melanin [Rozanowska, M., Bober, A., Burke, J. M. and Sarna, T.: The role of retinal pigment epithelium melanin in photoinduced oxidation of ascorbate. Photochem Photobiol 65: 472-479, 1997] and in mitochondrial damage [Godley, B. F., Shamsi, F. A., Liang, F. Q., Jarrett, S. G., Davies, S., Boulton, M.: Blue light induces mitochondrial DNA damage and free radical production in epithelial cells. J Biol Chem 280: 21061-6, 2005].

Evidence for free radical production in human skin exposed to UV-irradiation has been obtained indirectly (the detection of products of lipid-peroxidation, antioxidant depletion, and enzyme-inactivation) [Packer, L., Ultra-violet radiation (UVA, UVB) and skin antioxidants in “Free Radical Damage and its control”, C. A. Rice-Evans and R. H. Burdon (Eds.) 1994 Elsevier Science B.V.]. The ascorbate radical from vitamin C oxidation, and radicals assigned to lipid alkoxyl radicals which were trapped with DMPO were reported by Jurkiewicz and Buettner in 1996 [Jurkiewicz, B. A., Buettner, G. R.: EPR detection of free-radicals in UV-irradiated skin: mouse versus human. Photochem Photobiol 64, 918-922, 1996].

It is known that skin proteins such as collagen, keratin and elastin are important to the structural integrity of the skin, and that damage to these proteins are involved in the ageing and structural deterioration of the skin (“structural damage”), which is accelerated by sunlight. In particular, it is known that degradation and/or loss and/or aggregation and/or modification of these proteins, caused by radical reactions, is a primary cause of skin ageing and deterioration, characterised by cosmetically unwelcome symptoms such as wrinkling, sagging (loss of elasticity) and lines. In principle, a quantitative way of measuring these and other skin proteins and their degradation products would greatly assist research in relation both to intrinsic and solar (premature) ageing.

Furthermore, while the extent to which solar wavelengths other than UVB (classically linked with non-melanoma skin cancers) are involved in the initiation and/or promotion of skin cancers remains to be conclusively established, research is strongly suggesting a link. Whether structural damage is a precursor to, or otherwise associated with, the cancer initiation/promotion, or whether the structural damage and the cancer are merely independent outcomes of the common insults (e.g. UVA radiation and other wavelengths of solar radiation) suffered by the skin, is not known. Data is accumulating which demonstrates mutagenic lesions induced by UVA in human skin cells [Besaratinia, A., Bates, S. E., Synold, T. W. and Pfeifer, G. P.: Similar mutagenicity of photoactivated porphyrins and ultraviolet A radiation in mouse embryonic fibroblasts: involvement of oxidative DNA lesions in mutagenesis. Biochemistry 43; 15557-15566, 2004; Besaratinia, A. et al.: G- to T-transversions and small tandem base deletions are the hallmark of mutations induced by ultraviolet A radiation in mammalian cells. Biochemistry 43, 8169-8177, 2004; Courdavault, S. et al.: Larger yield of cyclobutane dimers than 8-oxo-7,8-dihydroguanine in the DNA of UVA-irradiated human skin cells. Mutation Research 556, 135-142, 2004].

The role of melanin in the induction of 8-hydroxydeoxyguanosine DNA damage in melanocytes and melanoma cells has been shown [Kvam, E. and Tyrell, R. M.: The role of melanin in the induction of oxidative DNA base damage by ultraviolet A irradiation of DNA or melanoma cells. J Invest Dermatol 113: 209-213, 1999; Wenczl, E. et al: Phaeomelanin photosensitises UVA-induced DNA damage in cultured human melanocytes. J Invest Dermatol 111: 678-682, 1998] and a higher proportion of UVA signature mutations in human squamous carcinomas in the progenitor-cell-containing basal layer (in comparison to UVB mutations, which occur predominantly in supra-basal keratinocytes and committed to terminally differentiate) were identified by Agar et al, and which are consistent with the greater penetration of UVA and visible light compared with UVB [Agar, N. S., Halliday, G. M., et al.: The basal layer in human squamous tumors harbors more UVA than UVB fingerprint mutations: A role for UVA in human skin carcinogenesis. Proc Natl Acad Sci U S A101: 4954-9, 2004]. The role of UVA in tumour promotion and progression, and oxidative stress in cutaneous carcinogenesis has been reviewed [Bachelor, M. A., Bowden, G. T.: UVA-mediated activation of signaling pathways involved in skin tumor promotion and progression. Sem Cancer Biology 14: 131-138, 2004; Sander, C. S., Chang, H., Hamm, F., Elsner, P., Thiele, J. J.: Role of oxidative stress and the antioxidant network in cutaneous carcinogenesis. Int J Dermatol 43: 326-335, 2004]. An ability to better relate structural skin damage to the natural and induced levels of melanin will enable the role of melanin to be better understood and may enable better understanding of the relative susceptibility of different racial groups (e.g. Caucasian, Asian, Afro-Caribbean and intermediate skin colours) to structural skin damage and to skin cancers, which may lead to improved treatment of these distressing cosmetic and medical conditions and to improved ways of protecting relatively susceptible individuals.

Oxygen-, sulphur- and carbon-centred radicals have been detected previously after exposure of the protein bovine serum albumin (BSA) to radical-generating systems [Davies, M. J., Gilbert, B. C., Haywood, R. M.: Radical-induced damage to proteins: ESR spin-trapping studies; Free Rad. Res. Commun. 1991, 15(2), 111-127; Davies, M. J., Gilbert, B. C., Haywood, R. M.: Radical-induced damage to Bovine Serum Albumin: role of the cysteine residue; Free Rad. Res. Commun. 1993, 18, 353-367]. This work demonstrates that proteins can undergo radical-induced damage, which may include fragmentation, cross-linking, decreased fluorescence, amino-acid composition changes, modifications of secondary, tertiary or quaternary structure, loss of function or any combination thereof. However, a quantitative assay for analysing damage to skin was not described.

Haywood et al. [Haywood, R., Wardman, P., Sanders, R. and Linge, C Sunscreens inadequately protect against ultraviolet-A-induced free radicals in skin: implications for skin ageing and melanoma? J Invest Dermatol 121; 862-868, 2003] have described the use of differential electron spin resonance (ESR) spectroscopy to measure the effectiveness of sunscreens at shielding human skin against solar or artificial UVA radiation. This work forms the subject of international (PCT) patent application No. WO-A-2004/039414. The ESR spectroscopy was used to measure particularly the levels of ascorbate radical generated in shielded skin in response to the UVA radiation, in comparison with a reference sample of skin having no or standardized shielding.

The disclosures of the above prior publications, including the international patent application, are incorporated herein to the extent permitted by applicable law.

While the ascorbate radical is useful for measuring a response of human or mammalian skin to incident UVA radiation, the extent of production of the ascorbate radical is not itself directly related to actual damage to skin proteins.

WO-A-2004/039414 briefly mentions that differential ESR spectroscopy can be used, in place of or alongside the measurement of ascorbate radical, to measure spin-trapped adducts of short-lived radicals generated in the skin on UV exposure, of which oxygen radicals—such as superoxide, alkoxyl, SO₃⁻ and hydroxyl—and carbon-centred radicals derived from proteins and lipids—such as alkyl radicals—are specifically mentioned, but without preference expressed.

The present invention aims to provide an improved assay for relatively high-molecular-weight skin proteins. The invention is based on the surprising finding that the natural mechanism of high molecular weight and other radical generation in the skin under light radiation, which is believed likely to arise directly from light absorption by the high molecular weight skin molecules (rather than via initial generation of other radical species) is quantitative and reproducible in comparative assays and that it can be quantitatively detected by using, in the presence of an excess of a suitable spin-trapping agent to prolong the residence time of the radical, a comparative ESR spectroscopic technique in which more than one ESR spectra are compared against one another, and preferably where line broadening in the spectra is used to identify high molecular weight motionally restricted spin adduct radicals. Moreover, the invention relies on the further findings that the skin samples return quickly, reproducibly and quantitatively to a resting condition of background radical generation on removal of the light radiation, without being affected by application, variation and removal of the applied ESR magnetic field and the presence of the spin-trapping agent. The use of these high molecular weight and other molecules as defined herein in comparative skin assays as markers for oxidative stress and its results, and in particular for skin damage, ageing and certain skin conditions, disorders and diseases is novel and hitherto unexpected.

### BRIEF DESCRIPTION OF THE INVENTION

According to a first aspect of the present invention, there is provided a method for determining the presence of high molecular weight molecules in human or other mammalian skin, comprising irradiating a sample of the said skin with light at one or more wavelengths present in solar radiation, in the presence of a spin-trapping agent for radicals of the said molecules, and using comparative electron spin resonance (ESR) spectroscopy to determine or investigate the presence of radicals of the said molecules induced in the skin by the light.

According to a second aspect of the present invention, there is provided a method for determining or investigating the presence of aminoacid molecules or protein fragments in human or other mammalian skin, comprising irradiating a sample of the said skin with light at one or more wavelengths present in solar radiation, in the presence of a spin-trapping agent for radicals of the said molecules, and using comparative electron spin resonance (ESR) spectroscopy to determine or investigate the presence of radicals of the said molecules induced in the skin by the light.

The comparative ESR spectroscopy is characterised by more than one ESR spectral measurement which are mutually comparable to the extent necessary for the method. For example, where a quantitative assay of the relevant molecules in a sample of skin is required, the ESR spectra may be obtained from a test sample of skin and a reference sample. The reference sample may be a sample of human skin or of an effective substitute therefor, about which sufficient information is known, and which is sufficiently comparable with the test sample, to serve as a reference. The test and reference samples will in that case generally be different but comparable. Where a sunscreen or an anti-ageing or other skin preparation, or a fabric, is being tested or evaluated, the ESR spectra may be obtained from a single sample of skin variously shielded and unshielded by the material being tested or evaluated, or variously shielded by the material being tested or evaluated and shielded by a reference material about which sufficient information is known, and which is sufficiently comparable with the material being tested, to serve as a reference.

According to a third aspect of the present invention, there is provided a method of determining whether human or other mammalian skin has suffered, or is susceptible to, structural damage, the method comprising determining or investigating the presence in the skin of high molecular weight molecules or aminoacid molecules or protein fragments using a method according to the first or second aspect of the present invention, and correlating the levels of the said molecules in the skin with structural damage or the susceptibility thereto by means of reference data for making the correlation.

According to a fourth aspect of the present invention, there is provided a method of diagnosing, and predicting a susceptibility to, skin conditions, diseases and disorders, for example skin cancers such as melanomas, the method comprising determining or investigating the presence in the skin of high molecular weight molecules or aminoacid molecules or protein fragments, using a method according to the first or second aspect of the present invention, and correlating the extent of presence of the said molecules in the skin with the presence of, or a susceptibility to, skin conditions, diseases and disorders by means of reference data for making the correlation.

According to a fifth aspect of the present invention, there is provided a method of testing or evaluating the effectiveness of sunscreens and anti-ageing and other skin preparations or fabrics in reducing the exposure of skin to damaging solar radiation and in reducing ageing or other structural damage to skin, the method comprising irradiating a sample of human skin or of an effective substitute therefor (herein: “skin”) shielded with the sunscreen composition or anti-ageing or other skin preparation or fabric to be tested or evaluated, with light at one or more wavelengths present in solar radiation, in the presence of a spin-trapping agent for radicals of high molecular weight molecules or aminoacid molecules or protein fragments induced in the skin by the light, and using comparative electron spin resonance (ESR) spectroscopy targeted to said molecules to test or evaluate the said effectiveness of the sunscreen composition or anti-ageing or other skin preparation or fabric. In particular, the ESR spectrum of the shielded skin sample targeted to said molecules is compared quantitatively with the corresponding ESR spectrum of a reference sample under substantially quantitatively comparable conditions. The reference sample is skin, optionally under shielding, and sufficient information is known both about the skin and about any optional shielding, to serve as a reference.

The method of the present invention is particularly suitable for use with human skin, and may be applied to skin of different racial types, to yield data concerning the relative susceptibility of different racial groups to structural skin damage and to skin cancers. In this use, the comparative ESR spectroscopy will typically compare ESR spectra from skin samples from the different racial groups under examination, and optionally one or more reference sample to establish comparability.

The method of the present invention may determine the levels of radicals of molecules induced directly in the skin by the light, as well as radicals of molecules generated in the skin by other induced radicals.

The comparative ESR spectroscopy will be performed using quantitatively comparable irradiation conditions for the irradiation of the skin samples. The irradiation conditions can be the same as between the test and reference samples, or the irradiation conditions can be different but quantitatively correlatable by reference to standardization data obtained for the skin samples under the different irradiation conditions.

The high molecular weight molecules have a molecular weight (as determined using standard measurement techniques) greater than about 4,500, for example greater than about 10,000, for example greater than about 15,000, for example greater than about 20,000, for example greater than about 25,000, for example greater than about 30,000. Preferably the high molecular weight molecules have a molecular weight less than about 400,000, for example less than about 350,000, for example less than about 200,000, for example less than about 150,000, for example less than about 100,000, for example less than about 80,000. They can be selected from proteins, lipids (e.g. phospholipids), polynucleotides (e.g. DNA), fragmented or degraded forms of any of the aforesaid, and any combination thereof. The most preferred high molecular weight molecules for detection using the present invention are naturally occurring skin proteins, skin lipids and skin polynucleotides, and naturally occurring fragmented or degraded forms thereof.

It is particularly preferred that the method of the present invention is used to determine and investigate levels of proteins in skin, particularly structural proteins such as, for example, keratin (e.g. acidic keratin or basic keratin), tropoelastin, elastin, tropocollagen and collagen, as well as fragments thereof. Acidic keratin has a typical molecular weight in the range of 56 to 40 kDa as measured by standard measurement techniques. Basic keratin has a typical molecular weight in the range of 67 to 52 kDa as measured by standard measurement techniques. Tropoelastin has a typical molecular weight of approximately 70 kDa as measured by standard measurement techniques and elastin generally has a higher molecular weight than tropoelastin. Tropocollagen has a typical molecular weight of approximately 300 kDa as measured by standard measurement techniques and collagen generally has a higher molecular weight than tropocollagen.

The aminoacid molecules can be selected from aminoacids having a molecular weight less than about 1,000, more particularly less than about 500. The aminoacid molecule may, for example, be a thioaminoacid, e.g. glutathione.

The protein fragments will have molecular weights less than the protein molecular weights.

The comparative ESR spectroscopy can be performed using reference molecules in comparative tests to investigate the nature and/or concentration of the radical species being detected by comparison with spectra obtained from known materials. For example, standard proteins such as bovine serum albumin (molecular weight 66,000) or other standard proteins of generally comparable molecular weights with the molecules to be detected can be used as quantitative comparison or reference systems.

The method of the present invention may, for example, be performed on a skin sample in vivo or an excised (ex vivo) skin sample or, for investigational or research use, on a sample of skin taken from surgical excess material, or on a sample skin substitute. The term “skin” used herein includes natural and substitute skin where the context permits.

The method of the present invention may be used to assign an ageing protection factor (APF) or skin damage protection factor (SDPF) to a sunscreen composition or an anti-ageing or other skin preparation or fabric. Such an APF or SDPF would particularly relate to the protection offered against ageing, skin structural damage and/or the susceptibility to skin cancers and other skin conditions, diseases and disorders associated with oxidative stress and radical formation. The method, which constitutes a further aspect of the present invention, comprises measuring the effectiveness of sunscreens and anti-ageing and other skin preparations or fabrics in reducing the exposure of skin to damaging solar radiation and in reducing ageing or other structural damage to skin using the method of the fifth aspect of the present invention, expressing the said effectiveness as the fraction (f) of unshielded induced radical production exhibited by the shielded skin, and assigning the APF or SDPF to the composition or preparation by virtue of the relationship:

APF or SDPF=1/f.

Alternatively, an ageing protection time (APT) or skin damage protection time (SDPT) may be assigned to a sunscreen composition or an anti-ageing or other skin preparation by determining, using the present invention, a time taken for skin damage to the test sample exposed to the light radiation to reach a defined measurable level, particularly a level representing a safe threshold level of exposure to solar radiation before unacceptable skin damage would occur. The use of the method of the present invention to assign an APT or SDPT to a sunscreen composition or an anti-ageing or other skin preparation or fabric constitutes a further aspect of the present invention.

According to a still further aspect of the present invention, there is provided a sunscreen composition or an anti-ageing or other skin preparation or fabric, to which an APF or SDPF or APT or SDPT has been assigned according to the method of the present invention. Such a sunscreen composition or anti-ageing or other skin preparation or fabric may preferably be for application to the skin at least once per day, and preferably has an APF or SDPF which is above a determined safe minimium protection factor—or an ADT or SDPT which is below a determined safe maximum protection time—for the latitude, season and/or climate in which the composition or preparation is to be used, calculated having regard to a safe maximum daily exposure to solar radiation and an assumed, expected or likely actual daily exposure to solar radiation at that latitude, season and/or climate. Alternatively or additionally, anti-ageing or other protective skin compositions or preparations or fabrics may be assigned a protection factor (PF)—by a method corresponding to the method described above for assigning an APF—which is above a determined safe minimum PF for environmental agents, other than sunlight, causing oxidative stress to the skin in a locality in which the anti-ageing or other protective skin compositions or preparations or fabrics are intended to be used, and correspondingly a protection time (PT).

The spin trapping agents are suitably agents which provide an adduct of the spin trap molecule with the radicals to be detected which has a substantially quantitatively stable lifetime of at least about 100 s, preferably at least about 1000 s and is measurable using ESR spectroscopy. The spin-trapped skin protein radicals may have a particularly long stable lifetime, for example more than about 24 hours, especially at high concentrations.

Certain of the detected molecules are novel chemical entities, and they constitute further features of the present invention.

Thus, in a further aspect, the present invention provides a spin-trapped polynucleotide radical, being an adduct of a polynucleotide (e.g. DNA, for example skin cell DNA such as human melanoma-derived DNA) radical with a spin-trapping agent therefor. In a still further aspect, the present invention provides a spin-trapped skin protein radical, being an adduct of a skin protein (e.g. a human skin protein) radical with a spin-trapping agent therefor. Such molecules have the potential to be sequenced in conventional manner, in order to provide valuable information directly linking human and non-human skin and other tissue damage, from a range of causative factors prevalent in the modem environment, with DNA damage in the skin or other tissues, for example due to mutations. From such information, treatments and diagnostic, prognostic and preventative methods can be developed to assist in combating the instances of skin and other tissue damage and its effects, including enabling susceptible individuals to adequately protect themselves in ways which hitherto have not been available.

It is envisaged that the trapping of DNA radicals might be used to assess the susceptibility of human DNA to free-radical damage as an indicator of an individual's likelihood of developing UV-induced skin cancer. It would be necessary to isolate and culture melanocytes from an individual skin sample, to obtain primary cells and DNA for irradiation and screening. DNA subject to irradiation in the presence of a spin-trap results in radical-adduct production (nitroxide radicals) which can be detected using ESR when sufficient radical concentrations are formed for radical detection. The reaction of an individuals DNA with a spin-trap also has the additional use of labelling sites of DNA damage and therefore mutation, since the reaction of a spin trap with a DNA radical covalently bonds the nitroxide moiety to DNA. Whilst the nitroxide radical will undergo decay over a period of time, the decay product of the spin-trap remains covalently bound to the macromolecule, effectively labelling the site of damage. This labelling of the damaged macromolecule has been already exploited in the identification of spin-trapped protein radical-adducts. For example, in the identification of the myoglobin tyrosyl radical by immuno-spin trapping (Detweiler, C. D., Lardinois, O. M., Deterding L. J., de Montellano, P. R., Tomer, K. B., Mason, R. P.: Identification of the myoglobin tyrosyl radical by immuno-spin trapping and its dimerization, Free Radic. Biol. Med. 2005, Apr. 1; 38(7):969-76) and antibodies to spin-traps are being developed (www.vincibiochem.it/PDFfiles/flver spintraps np final.pdf). It is anticipated that antibodies might be used to selectively locate damaged sites in DNA and proteins, thus—particularly with respect to DNA—it is possible that sites of gene mutation might be selectively targeted in DNA enabling gene mutations to be identified not only by UVA as a carcinogen which induces oxidative stress, but also other carcinogens which are carcinogenic via free-radical and oxidative stress induction. Thus, for example, oxidative DNA damage via metabolism (superoxide leakage and hydrogen peroxide production) in susceptible individuals might be located using immuno-spin-trapping possibly enabling genetic screening for susceptibility to oxidative damage.

### DETAILED DESCRIPTION OF THE INVENTION

The expression “human skin or an effective substitute therefor” used herein refers to human skin tissue or discrete human skin cells, and the tissue or discrete cells of any animal skin or other biological material (e.g. structural protein components of skin such as collagen, elastin and keratin) which provides a quantitative measurable radical response under solar radiation and is therefore equivalent to human skin for the purposes of this invention. Suitable animal skin may, for example, include natural animal skin and animal skin comprising genetically modified (e.g. humanized) cells. The skin may, for example, comprise chemically modified or cultured skin cells.

The expression “sunscreen composition or anti-ageing or other skin preparation” used herein includes any composition adapted or intended to have an effect of reducing the intensity of solar or artificial radiation incident on human skin when applied, usually directly, to that skin. Such compositions may include sunblocks, suncreams, sun lotions, anti-ageing creams, anti-wrinkle creams, moisturising creams, and general UV- or visible-protective cosmetic and medicinal creams or lotions. Generally speaking, such materials comprise a carrier, normally in the form of a liquid, cream, wax, paste, gel or the like, and an active radiation (e.g. UV or visible) absorbing or reflecting agent dissolved, mixed or suspended therein. The radiation absorbing or reflecting agent can be an organic or inorganic chemical with the capacity to absorb or reflect incident radiation in the visible or invisible (e.g. UV) wavelength range. Such materials and components are well known in the art, and a detailed description is not required here.

The expression “fabric” includes clothing articles, bandages and textile piece goods as well as cloth and any other fabric materials, whether fibrous, non-fibrous or mixed fibrous/non-fibrous; natural, synthetic or mixed natural/synthetic.

UV Radiation is generally speaking electromagnetic radiation having a wavelength in the range between violet light and long X-rays i.e. about 4-450 nm, for example about 4-400 nm. Visible light radiation is generally speaking electromagnetic radiation having a wavelength in the range about 400 to about 700 nm. Solar radiation includes UV and visible radiation, as well as other wavelengths.

The expression “Electron Spin Resonance” or “ESR” used herein refers to spectroscopy in which a resonance response is measured on exposure of unpaired electrons in a tested material to radiation of measurable frequency and wavelength. ESR spectroscopy is sometimes referred to as electron paramagnetic resonance or EPR spectroscopy.

### The Skin

The skin used in the present process is preferably freshly (i.e. less than about 48 hours previously, preferably less than about 24 hours previously) excised human skin tissue, which is maintained at a temperature above 0° C. and most preferably between about 0 and about 6° C. between excision and use. Less preferably, the skin may be stored between excision and use, e.g. at a temperature below about 0° C. The use of fresh skin avoids the build-up of background levels of free radicals and is found to produce an acceptably constant assay reading over the length of time taken to collect the data.

It is preferred to minimise variability in the skin samples used. Comparative tests in the present invention may use similar tissue from a standard part of the body and similar racial type. Alternatively, standardised cultured, cloned or otherwise engineered skin may be used, selected to have a high degree of reproducibility from sample to sample.

The skin sample may be irradiated from the epidermal or dermal side, and preferably the epidermal side.

The skin sample is mounted in a suitable radiation-inert support device for this purpose. By “radiation-inert” is meant a support device which does not affect the quantitative nature of the assay, and in particular which does not itself generate free radicals on exposure to the radiation. If desired, the back side of the skin sample (directed away from the radiation source) may be protected against irradiation by back-scattered light by a mask, e.g. of black adhesive tape, on the support device. The support device is preferably an ESR cell suitable for use in the ESR apparatus, as described below.

The skin samples used in the method of the present invention are preferably preincubated with the spin trapping agent prior to mounting in the support device and irradiation.

### The Radiation Source

The source of radiation preferably consists of a UV lamp or solar simulator which, according to the manufacturer's specification, emits UV and/or other radiation at the desired intensity and wavelengths selected from wavelengths present in solar radiation. Suitable filters may be used to remove unwanted wavelengths, in conventional manner. An example of a suitable low intensity UVA lamp is the super high pressure 100 W Nikon mercury lamp, model LH-M1100CB-1. An example of a suitable solar simulator, which operates at a higher intensity that a UVA lamp, is a 1000 W Applied Physics Clinical Photoirradiator, with which a WG320 Schott filter may suitably be used.

It is preferred that the radiation intensity is in the general range about 1 to about 100 mW/cm². When the intensity is towards the lower end of this range it is preferred that the radiation is delivered over a time period in the range of up to about 150 minutes, preferably about 60 to 100 minutes. When the intensity is higher, a shorter delivery time is preferable.

It is preferred that the irradiation of a skin sample takes place in situ in the cavity of the ESR apparatus, to minimise handling of the sample.

### The Radical Assay and the Assay Apparatus

The means for determining by electron spin resonance (ESR) spectroscopy the level of induced production of the measurable radicals in the skin on exposure of the skin to the radiation preferably consists of an ESR instrument, including sample container and sample handling devices, and associated signal processors and peripherals. Such an instrument, processors and peripherals are commercially available and the principles and materials of their construction and operation are known. An example of a suitable ESR instrument is the Bruker EMX spectrometer, available from (available from Bruker BioSpin GmbH, Division IX, Silbersteifen D-76287 Rheinstetten/Karlsruhe, Germany, Tel: ++49-721-5161-141, www.bruker.de). An example of a suitable sample container is the tissue cell WG 806-B-Q, available from Wilmad Lab Glass (1002 Harding Hwy., POB 688, Buena N.J. 08310 USA, Tel: ++856 697 3000, www.wilmad.com). It is preferred that the apparatus and method of the present invention are operated at approximately room temperature, i.e. in the temperature range of about 10 to about 30° C.

The level of induced production of the measurable spin-trapped radicals in the skin may suitably be quantified from one of the low-field peaks in relation to a suitable reference standard, for example Bovine Serum Albumin (BSA) or other reference material having a comparable molecular weight and anisotropy to the molecules to be measured (at a magnetic field between 3400 and 3600 Gauss), the peak height being determined from a base reference level, suitably the base line of the trace. The sweep width in the ESR spectroscopy should be at least about 100 Gauss and up to about 200 Gauss.

Alternatively, the area under the curve can be double integrated and compared with the area under a suitable reference curve (e.g. of 4-hydroxy-tempo or manganese 2+ crystals), obtained by double-integration of the reference curve, in order to quantify the level of induced production of the measurable spin-trapped radicals in the skin.

For tests where the effectiveness of a sunscreen composition or other skin preparation or fabric is to be tested in accordance with the present invention, the apparatus preferably comprises a radiation-inert support member having a surface capable of receiving and retaining a measured coating weight of the sunscreen composition or other skin preparation or fabric to be tested. By “radiation-inert” is meant a support member which does not affect the quantitative nature of the assay. The support member is preferably transparent to radiation, and preferably does not itself generate free radicals on exposure to radiation. The support member may suitably consist of a quartz slide locatable in the path of the radiation between the source and the skin sample, more preferably a cover slide adapted for use with the container (e.g. sample cell) for the skin sample.

The means for determining a quantitative measure of the extent of radical generation from the comparative ESR data obtained according to the present invention preferably comprises electronic signal processors and conventional associated electronic apparatus adapted to measure the differential or comparative signal height between the spectra and to display the result as a readout and/or printout in generally conventional manner. The provision of such apparatus and associated controlling software will be well within the capacity of one of ordinary skill in this art, and does not require further elaboration.

The apparatus according to the present invention may suitably be provided with one or more skin sample pre-installed, or may be adapted so that replacement or alternative skin samples can be easily substituted for an existing installed skin sample, without any need for handling of the sample. For example, one or more skin sample may be provided to a user of the apparatus in the form of a sealed “cassette” consisting of an ESR cell or other container holding the skin sample on a suitable mounting within the cell or container. Where a sunscreen composition or anti-ageing or other skin preparation or fabric is to be tested according to the present invention, a support member holding the composition or preparation or fabric to be tested will suitably be located between the cassette and the radiation source. Where it is desired to test sunscreen compositions on a range of different skin types (e.g. Caucasian, Afro-Caribbean, Chinese, etc.), an appropriate one of a series of interchangeable cassettes can simply be inserted into the apparatus. The apparatus according to the present invention may, for example, be used in a laboratory or a composition or preparation manufacturing facility for quality control purposes.

If desired, a skin sample used in the present invention may be irradiated outside the ESR apparatus. This is particularly desired when it is necessary to store the irradiated sample before it becomes convenient to run the ESR analysis. In such a case, the irradiated skin sample may be snap-frozen immediately after irradiation outside the ESR apparatus, and later thawed and subjected to the ESR analysis.

Spin Trapping Agents

Suitable spin trapping agents for use in the present invention are generally molecules which form a nitroxide species with the radical to be trapped. Such spin trap molecules include, for example, nitroso compounds and nitrone compounds. Specific examples include 5,5-dimethylpyrroline-N-oxide (DMPO), 3,5-dibromo-4-nitro-benzenesulphonic acid (DBNBS), N-t.butyl-α-phenylnitrone (PBN), α-(4-pyridyl-1-oxide)-N-t.butyl-phenylnitrone (POBN), 2-methyl-2-nitrosopropane, nitrosodisulphonic acid, 3,3,5,5-tetramethylpyrroline N-oxide, and 2,4,6-tri-t.butylnitrosobenzene, which are effective to stabilise radicals produced in the skin on radiation exposure, e.g. carbon-centred radicals derived from proteins and lipids such as alkyl radicals. With the high molecular weight molecules detected according to the present invention, such spin trapping agents form an adduct which exhibits slowly tumbling behaviour in solution, giving an anisotropic ESR spectrum with significant line broadening.

Further details of the techniques for quantitatively measuring spin trap adducts of generated skin radicals using ESR spectroscopy may be found in, for example, the Buettner and Jurkiewicz articles referred to above and incorporated herein by reference. The selection of suitable spin trap molecules and the techniques for handling, using and measuring them, will in any event be well within the capacity of one of ordinary skill in this art, and do not require detailed elaboration here.

The present invention will now be described in more detail, but without limitation, with reference to the specific Examples described below and illustrated in the accompanying drawings.

### BRIEF DESCRIPTION OF THE DRAWINGS

FIG. 1 illustrates the emission spectrum of sunlight (-♦- line) and that of the solar simulator equipped with a WG320 filter (--- line).

FIG. 2 illustrates ESR spectra of human Caucasian skin preincubated with 5,5-dimethylpyrroline-N-oxide (DMPO) (0.9 M in phosphate-buffered saline (PBS)): (a) unirradiated; (b) 0-15 minutes UV (mercury lamp irradiance 1.3 mW/cm² and epidermis exposed to the incident radiation); (c) 30 minutes UV; and (d) 60 minutes UV; as well as (e) the ESR spectrum of the protein bovine serum albumin (BSA) (mw 66,000) irradiated by the mercury lamp in the presence of DMPO. Spectra were recorded as described below in Materials and Methods, except the modulation amplitude was increased to 0.2 mT in (d).

FIG. 3 illustrates ESR spectra of human Caucasian skin preincubated with DMPO (0.9 M in PBS): (a) unirradiated; (b) 0-15 minutes UV (mercury lamp and dermis exposed to the incident irradiation; (c) 30 minutes IV; and (d) 60 minutes UV.

FIG. 4 illustrates ESR spectra of Afro-Caribbean skin preincubated with DMPO (0.9 M in PBS): (a) unirradiated; (b) 60 minutes UV (mercury lamp irradiance 1.3 mW/cm² and epidermis exposed to the incident radiation); (c) UV off. At 60 minutes irradiation the modulation is 0.2 mT to show the low-field shoulder to the intrinsic melanin radical (+).

FIG. 5 illustrates ESR spectra of Asian skin preincubated with DMPO (0.9 M in PBS): (a) unirradiated; (b) 0-15 minutes; (c) 30 minutes; (d) 60 minutes UV (mercury lamp and epidermis exposed to the incident radiation); and (e) UV off. (Modulation 0.2 mT at 60 minutes irradiation).

FIG. 6 illustrates ESR spectra of skin samples containing different levels of melanin pigmentation preincubated with DMPO (0.9 M in PBS) obtained subsequent to exposure to solar-simulated irradiation (approximately 2.8 mW/cm²): (a) Caucasian and 15 minutes irradiation; (b) Afro-Caribbean (15 minutes); (c) intermediate pigmented skin sample 1 (30 minutes); and (d) intermediate pigmented sample 2 (15 minutes). The spectra to the left in FIGS. 6a, 6c and 6d were obtained immediately after the solar simulator was switched off and the black tape at the back of the sample (present to prevent overlapping radical generation from back-scattered radiation) was removed; the spectra to the right in FIGS. 6a, 6c and 6d were obtained shortly after the spectra to the left, and illustrate the decay in signal strength, which can be quantified as a decay rate and thereby allowed for. The skin sample used for FIG. 6b was protected throughout by black tape at the back of the sample. The top signal trace in FIG. 6b was obtained before switching the solar simulator on, the middle signal trace in FIG. 6b was obtained with the solar simulator on, and the bottom signal trace in FIG. 6b was obtained after switching the solar simulator off (as the Afro-Caribbean skin sample in FIG. 6b produced no high molecular weight radicals, the traces shown in FIG. 6b are from the melanin part of the ESR spectrum, where overlapping signals from the black tape do not arise).

FIG. 7 illustrates a comparison of the ESR spectra obtained in skin samples of different pigmentation exposed to 15-30 minute solar-simulated light: (x) unidentified novel macromolecular radical; (o) lipid alkoxyl/glutathiyl radical; (+) intrinsic melanin radical in pigmented skin samples.

FIG. 8 illustrates how the ESR spectrum of a nitroxide radical changes from isotropic (freely tumbling with a rotational correlation time of 10⁻¹¹ s) to a rigid glass or powder anisotropic spectrum (rotational correlation time 10⁻⁷ s) upon a temperature decrease from 316-173 K [from Campbell, I. D. and Dwek, R. A. in “Biological Spectroscopy” Benjamin Cummings Pub. Co. Inc., California (1984), 179-217].

FIG. 9 illustrates ESR spectra of solid fat tissue (pig) incubated with DMPO (0.9 M) for 30 min: (a) control (non-irradiated); (b), (c) UVA-irradiated using the 100 W mercury lamp (100 and 500 seconds) and (d) subsequent to irradiation (UV off).

FIG. 10 illustrates ESR spectra of (a) SK23 melanoma cells incubated with DMPO (0.9 M) and exposed to UV irradiation; (b) isolated nuclei and DMPO and exposed to UVA; (c) isolated DNA and DMPO exposed to UVA, and (d) UV- irradiated DNA and DMPO.

FIG. 11 illustrates ESR spectra of DNA isolated from SK23 melanoma cells, the spectra obtained in the presence of DMPO: (a) non-irradiated; (b) UVA-irradiated, and (c) lamp off.

FIG. 12 illustrates ESR spectra for comparison between (a) UVA-irradiated Caucasian skin (epidermis facing light source); (b) bovine serum albumin (BSA); (c) Caucasian skin (dermis facing UV); (d) fat tissue (pig); and (e) human DNA; in each case pre-incubated with DMPO (0.9 M) and exposed to UVA-irradiation (100 W mercury lamp).

### DETAILED DESCRIPTION OF THE EXAMPLES AND DRAWINGS

### Materials

Human skin was obtained from consenting patients undergoing surgery. Skin was stored in N-saline-soaked gauze at 4° C. and used within 48 hours of excision as described by Haywood et al. in J Invest Dermatol 121; 862-868, 2003, the content of which is incorporated herein by reference. Prior to electron spin resonance spectroscopic (ESR) analysis, skin was trimmed if necessary to remove subcutaneous fat and cut to approximately 1 cm². DMPO (0.9 M in PBS) was purified before use by treatment with activated charcoal (1 g/10 ml). Incubations of skin with DMPO were carried out at room temperature (30 minutes) and the skin samples were blotted dry before ESR analysis. Skin samples were irradiated in situ in the cavity of an electron spin resonance spectrometer (see below under “Equipment”).

SK23 Melanoma cells were cultured in normal growth RPMI medium (Sigma, Dorset, UK) supplemented with 10% chelated FCS, 1% L-glutamine, 100 U/ml penicillin and 100 mg/ml streptomycin. Cells for ESR experiments were harvested and suspended in 0.25 ml DMPO solution (0.9 M in PBS or as otherwise indicated). To isolate cell nuclei, confluent melanoma cells were trypsinised and centrifuged (1000 rpm, 5 mins) and the pellets resuspended in freeze-thaw lysis buffer, and subject to three freeze-thaw cycles by freezing in liquid nitrogen/thawing on ice and vortexed 10 s. Nuclei were isolated by ultracentrifugation 700 g for 10 mins and obtained from the resultant supernatant after further centrifugation at 11,000 g for 10 mins. The nuclear pellet was resuspended in the minimal volume of sodium phosphate buffer pH 4.5 for irradiation with DMPO (final concentration 180 mM). DNA was extracted from SK23 melanoma cell pellets by suspending the pellet in NaCl (75 mM)/EDTA (25 mM) pH 8 buffer followed by lysis in Tris/EDTA buffer (pH 8) containing 1% SDS and 400 μg/ml proteinase K. DNA was then extracted with phenol then centrifuged at 14,000 rpm for 5 min; the aqueous phase was removed and the procedure repeated using phenol/chloroform, and then chloroform. DNA was precipitated overnight with ethanol and acetate (3M) solution. DNA was resuspended in 0.2 ml sodium phosphate buffer (pH 4.5) and 50 μl DMPO (0.9 M) for UVA-irradiations.

### Equipment

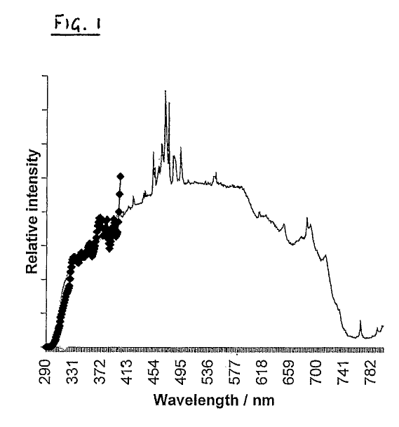

Electron-spin-resonance experiments were carried out using a Bruker EMX spectrometer (Rheinstetten/Karlsruhe, Germany) equipped with an ER 4103TM cavity and a Wilmad Glass Co. tissue cell (WG 806-B-Q) (Buena N.J.). Typical ESR settings were 20 mW microwave power, 0.075 mT modulation amplitude, 2×10⁵ receiver gain, sweep time 5×20 seconds or 1×335 seconds. Light irradiation was carried out in situ in the spectrometer (with the cavity completely shielded by black plastic sheeting) using either a super high-pressure 100 W Nikon mercury lamp (model LH-M1100CB-1) focussed on the cavity transmission window, or solar simulated irradiation (1000 W Applied Physics Clinical Photoirradiator solar simulator, using a WG320 Schott filter) directed as a divergent beam through a fibre-optic probe on to the front of the ESR cavity window. The emission spectrum of the 100 W mercury lamp has been shown previously in J Invest Dermatol 121; 862-868, 2003. A 5 cm water filter was used to remove infra-red radiation together with two optical glass filters having a combined thickness of 0.7 cm (Barr and Stroud) filtering wavelengths below 300 nm and having a 1% transmittance of UVB radiation at 300 nm and 19% at 320 nm (visible wavelengths were not filtered). The UV fluence incident upon the sample within the spectrometer was measured previously to be 3 mW (calculated irradiance 1.3 mW cm⁻²) [Haywood et al., J Invest Dermatol 121; 862-868, 2003]. The emission spectrum of the solar simulator is shown in FIG. 1. Also shown in FIG. 1 is the ultraviolet part of the emission spectrum of sunlight (290-400 nm) for comparison. The irradiance of the solar-simulated light was measured inside the ESR cavity using actinometry. A potassium ferrioxalate actinometer was used as described previously [Haywood et al., supra], except the method was adjusted for higher irradiance levels when the fibre-optic probe was placed at a short distance from the ESR cavity window (in this study 11 cm distance). For high irradiance, the actinometer was irradiated for a shorter time (2.5 minutes) and the measurement of irradiance adjusted twofold to compare directly with low intensity measurements (period of irradiation 5 minutes). The irradiance typically used in this study was 2.8 mW/cm².

### Results

### Test Data

### (i) Mercury Lamp Irradiations

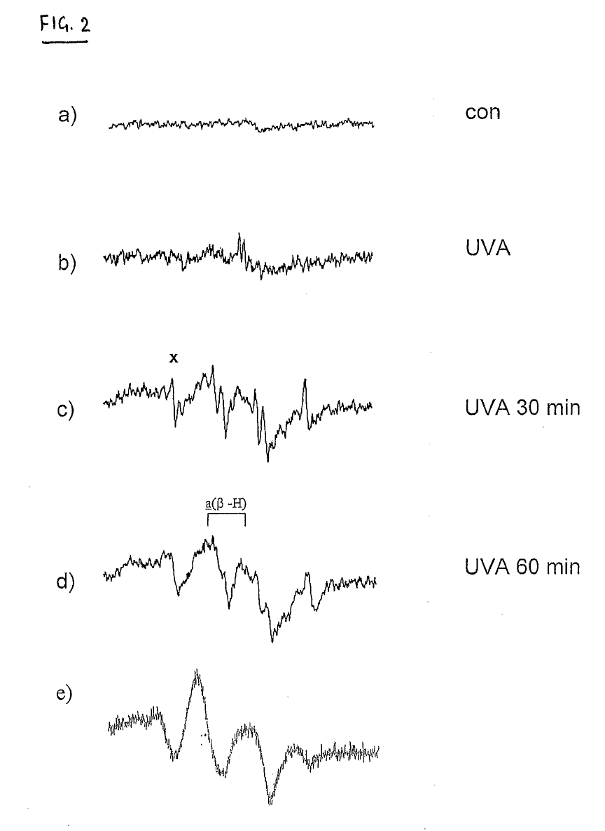

FIG. 2 shows the ESR spectra obtained when human Caucasian skin was UV-irradiated with 5,5-dimethyl-1-pyrroline N-oxide (DMPO) (transferred to the skin by 30 minutes incubation at room temperature). The skin samples are mounted with the epidermis exposed to the incident radiation. The ascorbate radical is the first radical to be detected upon irradiation (FIG. 2b); then isotropic spin-adducts of DMPO (a(N)=1.59 and a(H)=1.8 mT) (x) consistent with the trapping of low-molecular-weight radicals were detected at about 30 minutes irradiation (FIG. 2c), and anisotropic spin adducts consistent with the trapping of high-molecular-weight radicals were evident at about 30 minutes irradiation and predominantly detected at about 60 minutes irradiation (FIG. 2d).

The low-molecular-weight radicals have a β-H hyperfine splitting (1.8 mT) which is slightly higher than the β-H splitting of the alkoxyl radical reported by Jurkiewicz and Buettner (supra) (hyperfine splittings a(N)=1.45, a(H)=1.6 mT). The spectrum of the low-molecular weight spin-adduct we detect is a six-line spectrum that otherwise closely resembles that described by this group. Our skin samples differ from those used previously by Jurkiewicz and Buettner (supra) principally in that they had not been pre-frozen prior to experimentation, and thus are more likely to contain intact cellular architecture. In addition, in our experiments delivery of the spin-trap was via incubation of the whole skin sample in phosphate-buffered saline (PBS) containing DMPO, as opposed to epidermal topical application for 10 minutes. Thus, these differences between our results and those obtained previously by Jurkiewicz and Buettner (supra) may reflect either differences in the cellular environment (caused by cell disruption from freezing) or possibly the incubation in PBS compared to topical delivery in H₂O. The low-molecular-weight DMPO spin-adduct we have detected may be the same as that reported previously (a lipid-alkoxyl radical) or alternatively may be a sulphur-centred (e.g. glutathiyl) spin-adduct of DMPO (usually 1.41.8 mT) [Buettner, G. R. (1987) Spin-trapping: ESR parameters of spin-adducts. Free Rad. Biol. Med. 3, 259-303; Davies, M. J., Gilbert, B. C. and Haywood, R. M.: Radical-induced Damage to Proteins: E.S.R. Spin-trapping Studies. Free Radical Research Communications, 1991, 15, 111-127]. Jurkiewicz and Buettner (supra), did not discuss the possibility of a glutathiyl radical. The assignment to lipid alkoxyl radical-adducts is consistent with the UVA-induction of lipid-peroxidation in skin. However, the detection of sulphur radicals (eg. a(H)=1.68 mT of a thiyl spin-adduct from photolysis of disulphide and a(H)=1.62 mT from horseradish peroxidase, hydrogen peroxide and glutathione) cannot be completely ruled out, since the oxidation of glutathione to glutathiyl radicals is part of the cellular protection against oxidative damage. The high molecular weight radicals which are detected at 60 min irradiation time have spectral characteristics of sulphur-centred radical spin-adducts.

The anisotropic spectrum shown by the broad lines in FIG. 2d is believed to reflect the trapping of one or more high-molecular weight skin radicals. Anisotropy (line-broadening) is known to arise when a radical is motionally restricted. This can be an increased rotational correlation time (time for one complete rotation of the molecule) reflecting the immobilization of a low-molecular weight radical in a solid due to freezing, or when a radical is covalently bound to high molecular weight macromolecules such as proteins and DNA. It has been demonstrated that the ESR spectrum of a nitroxide radical changes from isotropic (freely tumbling with a rotational correlation time of 10⁻¹¹ s) to a rigid glass or powder anisotropic spectrum (rotational correlation time 10⁻⁷ s) upon a temperature decrease from 316-1731K [Campbell, I. D. and Dwek, R. A. in “Biological Spectroscopy” Benjamin Cummings Pub. Co. Inc., California (1984), 179-217]. The spectral change is shown in FIG. 8 of the accompanying drawings.

The local rotational freedom of the nitroxide covalently bound to a slowly tumbling molecule (i.e. binding site) also contributes to the anisotropy of the ESR spectrum; a freely rotating nitroxide on a slowly tumbling molecule can appear moderately immobilized, in contrast to the highly immobilized spectrum of a nitroxide which is restricted in its local freedom of motion as well as undergoing slow molecular tumbling. The anisotropic spectrum in FIG. 2d is characteristic of a nitroxide radical, which is strongly immobilized. Strongly immobilized nitroxide radicals have been observed when the protein bovine serum albumin (Mw 66,000) reacts with the hydroxyl radical and DMPO to from a protein radical-adduct of DMPO; when methaemoglobin (Mw 64,500) reacts with hydrogen peroxide and the spin trap DBNBS, and when lysozyme (Mw 14,600) reacts with the methanol radical and DBNBS [Davies, M. J., Gilbert, B. C. and Haywood, R. M.: Radical-induced Damage to Proteins: E.S.R. Spin-trapping Studies. Free Radical Research Communications, 1991, 15, 111-127; Davies, M. J., Gilbert, B. C. and Haywood, R. M.: Radical-induced Damage to Bovine Serum Albumin: Role of the Cysteine Residue. Free Radical Research Communications, 1993, 18, 353-367].

Whilst proteins with a molecular weight of the order 15,000 were found previously to be associated with both strong and moderate immobilization to varying degrees (with some occasional unrestricted freedom of motion) only protamine radical-adducts (Mw 4,500) were associated with the isotropic spectra of nitroxides with relatively unrestricted freedom of motion. Thus, the novel radicals identified here are likely to have a molecular weight in excess of 4,500 [Davies, M. J., Gilbert, B. C. and Haywood, R. M.: Radical-induced Damage to Proteins: E.S.R. Spin-trapping Studies. Free Radical Research Communications, 1991, 15, 111-127; Davies, M. J., Gilbert, B. C. and Haywood, R. M.: Radical-induced Damage to Bovine Serum Albumin: Role of the Cysteine Residue. Free Radical Research Communications, 1993, 18, 353-367].

The high degree of anisotropy of nitroxide radicals formed in the skin after irradiation suggests the trapped radicals are macromolecular and are believed to be protein—rather than lipid-derived; since lipid-immobilised nitroxides generally have slightly greater rotational freedom than nitroxide radicals bonded to the surface of a protein; however, the possibility of a lipid or other high molecular weight species cannot be completely ruled out at this stage. Oxygen-, sulphur- and carbon-centred radicals have been detected previously after exposure of the protein bovine serum albumin (BSA) to radical-generating systems [Davies, M. J., Gilbert, B. C. and Haywood, R. M.: Radical-induced Damage to Proteins: E.S.R. Spin-trapping Studies. Free Radical Research Communications, 1991, 15, 111-127; Davies, M. J., Gilbert, B. C. and Haywood, R. M.: Radical-induced Damage to Bovine Serum Albumin: Role of the Cysteine Residue. Free Radical Research Communications, 1993, 18, 353-367]. Irradiation of BSA in the presence of DMPO using the mercury lamp resulted in the detection of an immobilized nitroxide with similar features to that detected in UVA-irradiated skin samples (shown in FIG. 2e).

This experiment suggests that protein radicals can be formed by direct UV absorption, in addition to the indirect formation from reaction with externally generated radical species. Since it is believed that DNA does not absorb UV directly (unless photosensitisers are present), the radicals detected could reflect UV-photodamage to skin proteins (possibly collagen, keratin or elastin) at 60 minutes irradiation time. Two skin samples were irradiated at this intensity: one was characterized by low-molecular weight radicals and high molecular weight radical-adducts of DMPO, whilst the other was characterized by only the high molecular weight radicals.

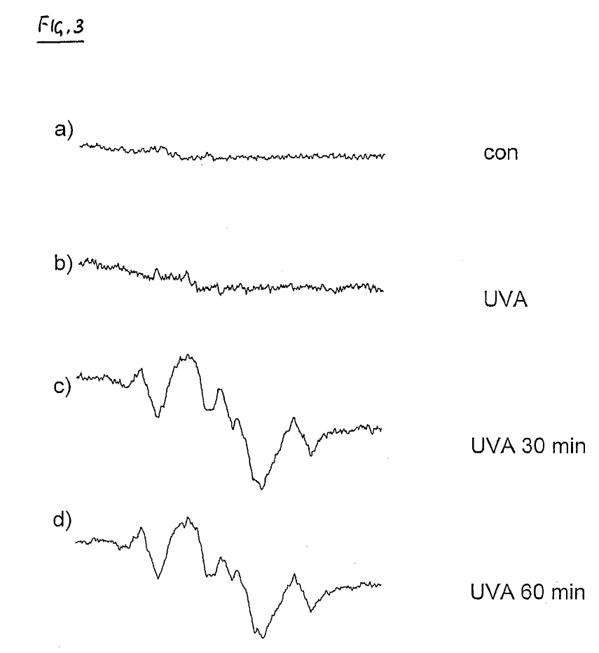

FIG. 3 shows the results of skin preincubated with DMPO and irradiated under comparable conditions, but mounted with the dermis rather than the epidermis exposed to the incident UV radiation. The first radicals to be detected are the anisotropic spin-adducts (corresponding to high-molecular-weight species) and subsequently low molecular-weight spin-adducts (not shown). It is possible that a mixture of adducts have been detected, but the spectrum is more typical of immobilized sulphur-centred spin-adducts of DMPO. This experiment suggests that the anisotropic spin-adducts may correspond to damage to deeper components of the epidermis/dermis whilst the low molecular-weight spin-adducts (and presumably the ascorbate radical) reflect cellular damage within the epidermis.

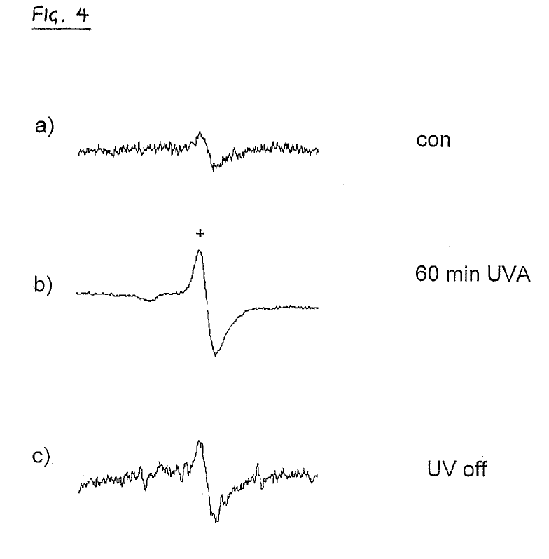

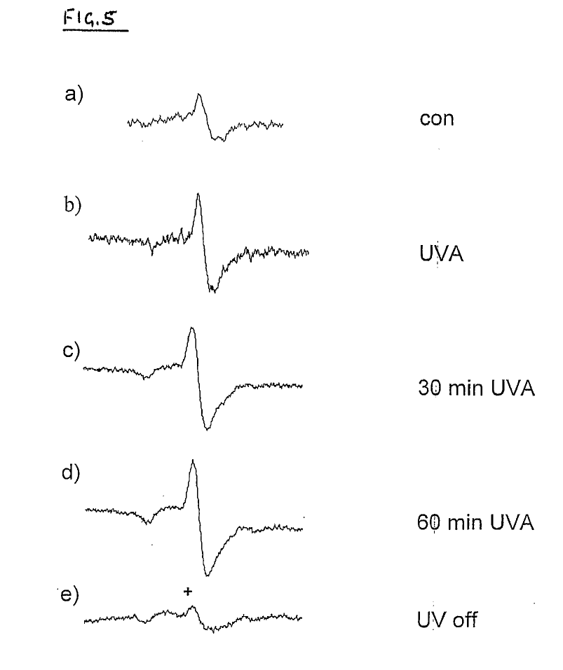

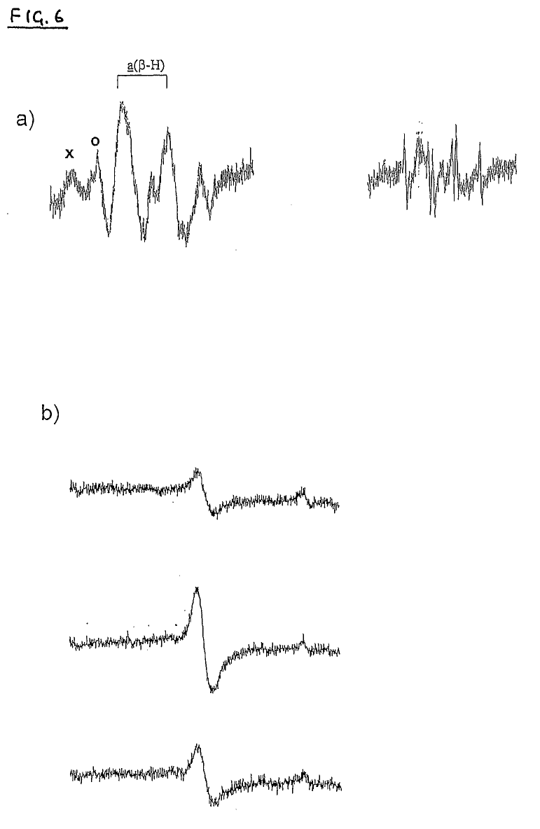

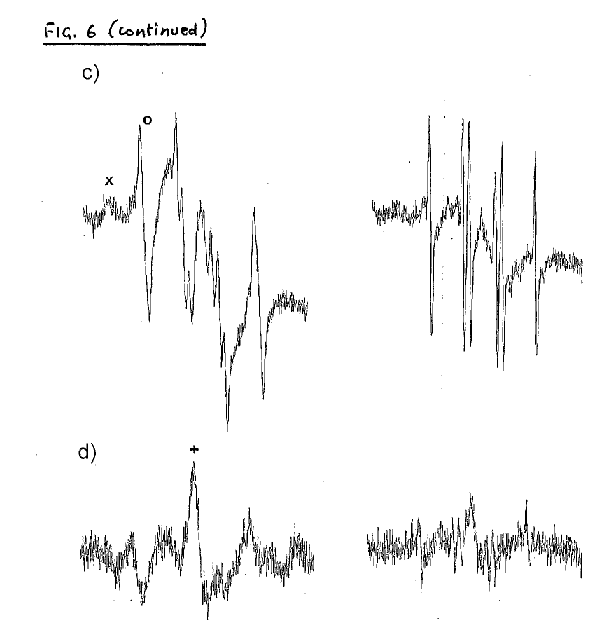

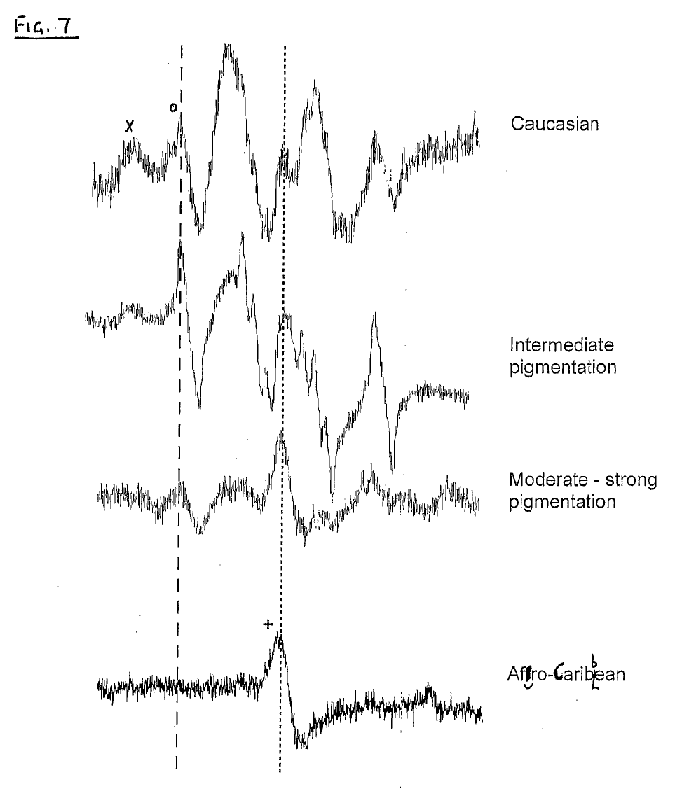

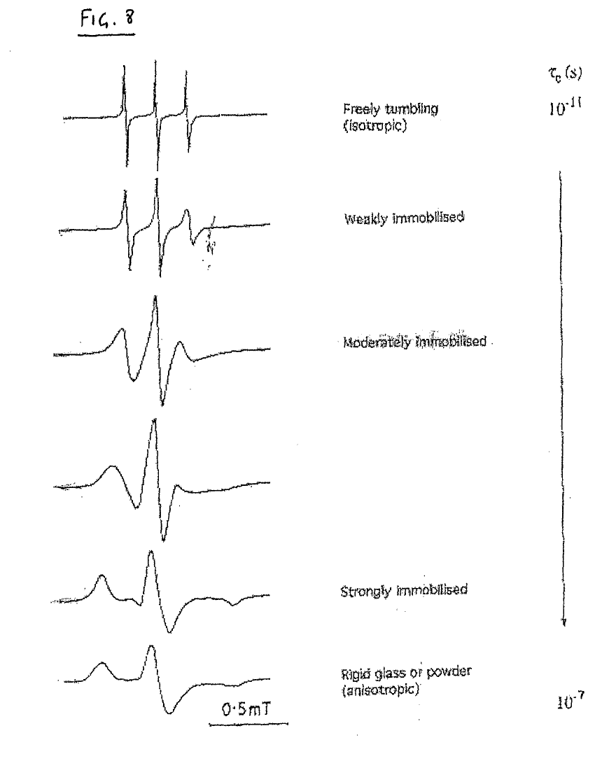

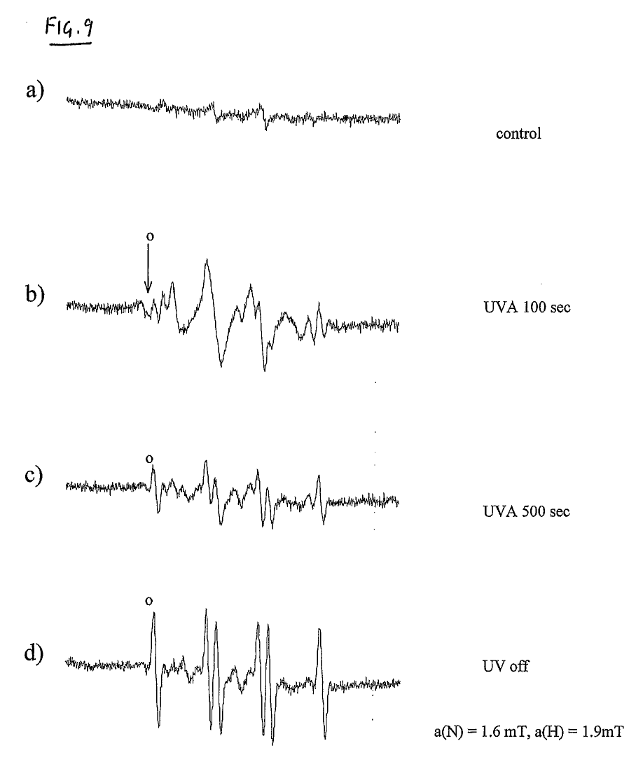

FIG. 4 shows the results of the irradiation of Afro-Caribbean skin using the mercury lamp: the radicals that could be detected in Caucasian skin after 30-60 minutes irradiation can barely be detected at 60 minutes irradiation time; however, there is slight evidence of broadening low field of the intrinsic melanin radical signal (+). UV irradiation of Asian skin gave the ESR spectra shown in FIG. 5: Asian skin was more protected than Caucasian skin against radical production; however, a low-field shoulder to the intrinsic melanin radical could be detected at 60 minutes irradiation, which remained visible upon cessation of irradiation (+). This low-field shoulder has spectral characteristics of phaeomelanin.

It is concluded that UV irradiation of Caucasian skin generates initial ascorbate radical generation, and low-molecular-weight radicals that might be lipid-alkoxyl radicals as previously reported (Jurkiewicz and Buettner, supra) but might possibly be glutathiyl radicals from the oxidation of the antioxidant glutathione. After about 60 minutes irradiation, radical damage becomes significant to macromolecular, likely protein (collagen, keratin or elastin), components apparently in the deeper layers of epidermis/dermis. Afro-Caribbean and Asian skins containing high concentrations of melanin are better protected against UV-induced radical formation than un-pigmented Caucasian skin after 60 minutes irradiation at this irradiation intensity.

To investigate the generation of lipid radical intermediates further, solid fat tissue (pig), rich in lipids, was incubated with DMPO and UVA-irradiated under comparable conditions. FIG. 9 shows the results obtained. Radicals with a degree of motional restriction were detected initially (at 100 s) but after 500 s irradiation only isotropic ESR spectra of an oxygen centre adduct (a(N)=1.6 mT, a(H)=1.9 mT) could be detected The broad spectrum initially detected appears to have features of an immobilized oxygen centred adduct (deduced from comparison with data of slowly tumbling radical-adducts of DMPO). The increase in mobility of the adducts detected at later irradiation times may reflect a decreasing viscosity of the lipid environment due to peroxidation and increasing fluidity, or that the radicals with greater motional freedom (which are trapped by DMPO to give relatively stable adducts) are formed at later stages in the peroxidation reaction, possibly after fragmentation. This data confirms that biological tissue rich in lipid undergoes direct UVA-induced lipid peroxidation with the production of radical intermediates which are similar to those detected in UVA-irradiated skin samples. This data supports the original assignment of Jurkiewicz and Buettner of the isotropic radical-adduct detected in skin to a lipid, possibly lipid alkoxyl radical intermediate.

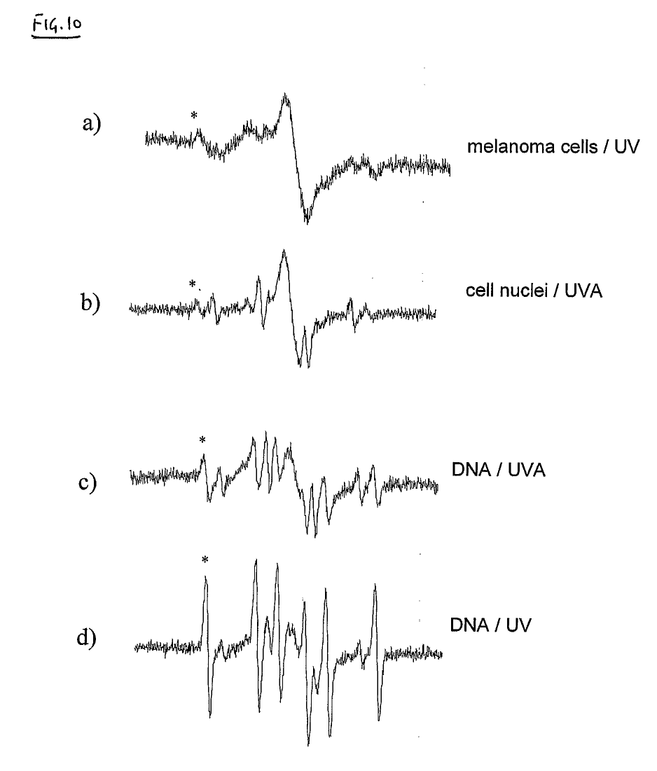

The ESR spectrum in FIG. 10(a) shows that UV-irradiation of human melanoma cells in the presence of DMPO results in the detection of a carbon-centred radical-adduct with DMPO, which was also identified in the nuclear fraction isolated from these cells exposed to UVA (in addition to superoxide and hydroxyl radical-adducts of DMPO) (FIG. 10(b)). This suggests that the carbon-centred radical detected with DMPO in the intact cell could correspond to radical reactions occurring within the nucleus. When genomic DNA was isolated to a high concentration and exposed to both UVA only (plus glass filters) (FIG. 10(c)) and then UV (by omitting the glass filters in the mercury lamp system) (FIG. 10(d)) in the presence of DMPO, carbon-centred radical-adducts of DMPO comparable to that observed both in intact cells and intact nuclei were observed. The extracted DNA contained melanin, and since it is believed that DNA does not absorb UVA directly, it is likely that the melanin present in this preparation catalyses DNA photo-oxidation and DNA radical formation. It is unlikely that the carbon-centred radicals detected with DMPO are melanin-derived radicals: although it is well established that melanin photosensitizes both superoxide and hydroxyl radical-adducts, which can be detected by DMPO, in all the studies of the UV irradiation of melanin to date there have been no reports of the detection of carbon-centred radicals (with the exception of oxidized melanin exposed to 694 nm ruby laser irradiation).

There are two types of photosensitization mechanism: type I, involving direct interaction between the triplet photosensitiser and substrate, and type II, where the triplet photosensitiser interacts with triplet oxygen to form singlet oxygen which the reacts with the substrate. It is known that melanin can form a triplet state upon UV photoexcitation and that the triplet state of melanin can react with oxygen to form the superoxide radical; however, there have been no reports to date that melanin can photosensitise the formation of singlet oxygen. Thus, it would appear more likely that the excited state of melanin either reacts with oxygen to form the superoxide radical, which reacts with DNA to form a DNA radical, or reacts with DNA directly. In addition, it has also been shown previously that melanin can act as an electron transfer agent in the photo-oxidation of ascorbate (Rozanowska, M., Bober, A., Burke, J. M., and Sarna, T. The role of retinal pigment epithelium melanin in photoinduced oxidation of ascorbate. Photochem. Photobiol. 1997, 65, 472-479) with the reduction of oxygen to superoxide.

Therefore, the carbon-centre radical-adduct we have detected (see FIG. 10) is believed to be a DNA radical, which is formed as a result of melanin acting photocatalyically in DNA oxidation. The detection of a hydroxyl radical-adduct of DMPO in the UVA-irradiated DNA-melanin system suggests the possibility of superoxide production (and subsequent decay to a hydroxyl radical-adduct) although at the pH used (4.5) it would be expected that the superoxide radical-adduct itself would be detected. While we should be cautious to draw conclusions about the mechanism of damage at this stage, it would appear more likely that triplet state melanin reacts directly with DNA and with oxygen (to form superoxide), rather than reacting with oxygen to form singlet oxygen.

The detection of carbon-centred radicals in UVA-irradiated DNA suggest the possible trapping of sugar radicals, possibly from initial base (nucleotide) damage with subsequent intramolecular radical transfer. It has been demonstrated recently that UVA-visible photoexcitation of guanine radical cations produces sugar radicals in DNA and model structures (Adhikary, A., Malkhasian, A. Y., Collins, S., Koppen, J., Becker, D., and Sevilla, M. D.: UVA-visible photo-excitation of guanine radical cations produces sugar radicals in DNA and model structures, Nucleic Acids Res. 2005, 33, 5553-5564; Adhikary, A., Kumar, A., and Sevilla, M. D.: Photo-induced hole transfer from base to sugar in DNA: relationship to primary damage. Radiat. Res. 2006, 165, 479-484). It is well established that 8-hydroxydeoxyguanosine is a product of DNA photo-oxidation by UVA in intact cells and tissues (Kvam, E. and Tyrell, R. M., Induction of oxidative DNA base damage in human skin cells by UV and near visible irradiation, Carcinogenesis 1997, 18, 2379-2384), although more recently it has been suggested that cyclobutane dimers are produced in greater yield than 8-hydroxydeoxyguanosine in UVA-irradiated human skin cells, suggesting a photosensitized triplet energy transfer (Coudavault, S., Baudouin, C., Charveron, M., Favier, A., Cadet, J., and Douki, T., Larger yield of cyclobutane dimers than 8-oxo-7,8-dihydroguanine in the DNA of UVA-irradiated human skin cells, Mutation Res. 2004, 556, 135-142).

Guanine radical cations are putative intermediates in DNA oxidation to 8-hydroxydeoxyguanosine and are relatively stable at low temperatures and can be detected using ESR (Cai, Z., and Sevilla, M. D., Electron and hole transfer from DNA base radicals to oxidized products of guanine in DNA, Radiat. Res. 2003, 159, 411-419). Significantly, a radical with characteristics of DNA radical cations/anions is observed in UVA-irradiated DNA in addition to the spin-trapped carbon-centred radical (FIGS. 10(c) and 10(d)).

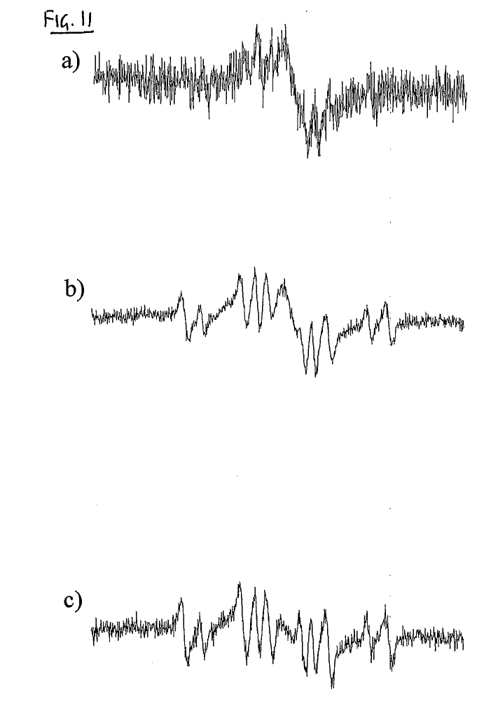

FIG. 11(a) shows a background (non-irradiated) ESR spectrum of the isolated melanoma cell DNA used in FIG. 10(c) in the presence of DMPO. FIG. 11(b) corresponds to FIG. 10(c) and shows the corresponding spectra of the isolated DNA after UVA irradiation with a 100 W mercury lamp. FIG. 11(c) shows that the ESR spectrum of FIG. 11(b) does not decay at least in the period of 100 s after the UVA lamp is switched off, which was the delay before the spectrum was obtained.

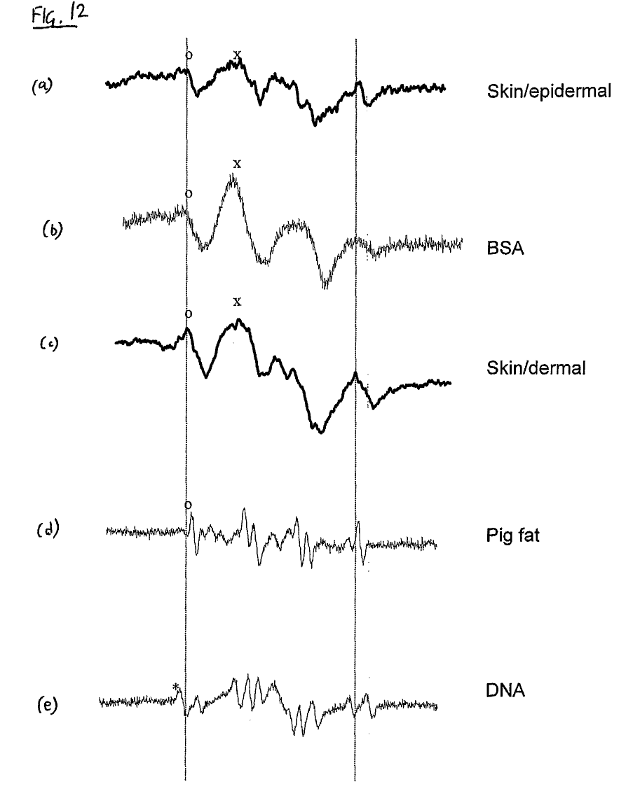

FIG. 12 brings together the particular ESR spectra from the work reported in this patent application, to allow the reader to see more easily the differences between them.

### (ii) Solar Simulated Irradiations

Skin samples with different levels of pigmentation were exposed to solar-simulated light in situ in the ESR spectrometer. The UV component of the solar simulated light was approximately twice that of the mercury lamp (2.8 mW/cm² compared to 1.3 mW/cm²). Since the solar-simulated light was a higher intensity than that of the mercury lamp, the method was adapted slightly to irradiate the skin samples with dermal protection (using a black tape), which was removed just prior to ESR analysis.

ESR analysis with the black tape present complicated the ESR spectrum due to the interference of radical signals present in the black tape, which overlapped with the spin-adduct ESR spectra of radicals trapped in skin (particularly Caucasian). Since it was necessary to remove the tape prior to ESR analysis, there was a short time delay between cessation of irradiation and obtaining the ESR spectrum, during which time there may have been some loss of signal intensity of the radical-adducts.

FIG. 6a shows the ESR spectra obtained immediately after exposure of a Caucasian skin sample to solar-simulated light for 15 minutes. Low molecular weight spin-adducts (o) a(N)=1.57 mT and a(H)=1.8 mT (better distinguished in the right-hand scan) and high-molecular weight spin-adducts of DMPO (x) with the characteristics of immobilized carbon-centred radical-adducts of DMPO are detectable subsequent to cessation of irradiation. FIG. 6b shows the ESR spectra obtained before irradiation (top trace), after comparable irradiation of Afro-Caribbean skin after 15 minutes (middle trace), and with the light off (bottom trace). The radical-adducts detected in Caucasian skin were not detected in this highly pigmented skin sample. FIG. 6c shows the ESR spectra of a pigmented skin sample (containing melanin but not as clearly distinguishable as Afro-Caribbean or Asian) obtained immediately after 30 min solar-simulated irradiation. In this sample, low-molecular weight adducts (o) a(H)=1.8 mT and high molecular weight spin-adducts of DMPO (x) (believed carbon-centred radical-adducts) were detected. In addition, a weak signal due to an as yet unidentified radical may also be present. Significantly, from this data it was surprising that the signal-intensity of the low-molecular weight radical-adducts was higher than that usually detected in Caucasian skin, since this radical is currently believed (on the basis of current literature) to be a lipid-alkoxyl radical. In addition, this radical remained detectable for a considerable time after the lamp was turned off. On the basis on the current accepted interpretation of Jurkiewicz and Buettner, this skin sample containing some melanin pigmentation is undergoing UV-induced lipid-peroxidation to a greater extent than Caucasian skin. If, however, this radical-adduct is a trapped glutathiyl radical, these results would be consistent with a higher level of glutathione in this skin sample. FIG. 6d shows ESR spectra obtained from a second pigmented skin sample (again containing melanin but not sufficiently pigmented to be Afro-Caribbean or Asian) exposed to 15 minutes of solar-simulated irradiation. In this sample, a relatively weak signal due to the high-molecular weight radical-adduct of DMPO was detected after irradiation (+), as well as a weak signal due to low-molecular weight radicals more clearly distinguished in the second scan after the light was switched off.

FIG. 7 shows a comparison of the results obtained from the different skin samples exposed to solar-simulated light (15-30 minutes), and arranged in order of increasing pigmentation (as measured by the intrinsic melanin radical signal-intensity (+). The nature of the samples is indicated in the figure. The signal-intensity of the high molecular weight spin-adduct (sulphur- and/or carbon-centred radicals) is found to decrease with level of melanin pigmentation in the skin, being maximal in Caucasian skin and minimal in Afro-Caribbean skin. The signal-intensity of the low-molecular weight radicals, whilst weak or undetectable in the skin samples with the highest pigmentation, are higher in the skin sample with intermediate pigmentation compared to the Caucasian skin sample. On the basis of the existing assignment, this suggest that the intermediate skin sample undergoes UV-induced lipid peroxidation to the greatest extent, but if this radical is a glutathiyl radical then this finding could reflect higher levels of glutathione in the sample with intermediate pigmentation than the Caucasian skin sample.

### Conclusions

It is concluded that UV-irradiation of unprotected human Caucasian skin exposed to UV from a mercury lamp (low irradiance 1.3 mW/cm²) under these experimental conditions results in radical production consistent with previous reports. The ascorbate radical (from the oxidation of vitamin C) is the first radical to be detected; subsequent low molecular weight species (at 30 mins) are believed to be either lipid-alkoxyl radicals as reported previously, or could possibly be glutathiyl radicals from the oxidation of the antioxidant glutathione. At longer irradiation time (60 min) we detect novel macromolecular spin-adducts of DMPO, which we believe at this stage to be protein radical-adducts of DMPO. Comparable irradiation of Afro-Caribbean and Asian skin does not result in the detection of similar radical species, although there is some evidence of a radical low-field of the intrinsic melanin radical at 60 min irradiation in Afro-Caribbean skin, and this to a slightly greater extent in Asian skin. The radical low field of the melanin radical has spectral characteristics of phaeomelanin.

The high levels of melanin pigmentation in Afro-Carribean and Asian skin appears to be predominantly protective, at the irradiance used, against the UV-induced radical formation which can be detected in the Caucasian skin lacking melanin pigmentation. Our experiments with solar-simulated light at higher intensity further corroborated these observations: Afro-Carribean skin was protected against the radical species detected in Caucasian skin, even when subject to the higher intensity irradiation. The skin samples with intermediate pigmentation, however, appeared variable in their protection against UV-induced radical production according to currently accepted interpretations of skin ESR spin trapping data; however, a different interpretation of lipid-alkoxyl radicals as glutathiyl radicals would give a different picture.

Whilst this study was limited to a small number of skin samples, we observe that the UV-induction of radical-damage to skin in terms of the formation of high molecular weight radicals (believed protein radicals keratin, collagen or elastin in the deeper epidermal/dermal parts of the skin) decreases with the level of melanin pigmentation in the skin sample.

These results demonstrate that ESR spin-trapping is potentially very useful for assessing UV-induced radical damage to skin. Furthermore, we have shown for the first time that high molecular weight radical species can be detected, which are believed to correlate with damage to the structural components of skin. The novel radicals potentially form a significant marker of damage to the structural components of skin and are potentially very useful for the assessment of the protection of sunscreens and anti-aging creams against UV-induced damage to skin. This methodology can clearly give a “radical profile” of different skin types in their responses to ultraviolet light and can be used to investigate the different age and individual responses in addition to different racial types to sunlight of different intensities. In this study, the samples were limited to three Caucasian skin samples, three pigmented which could clearly be identified as Asian or Afro-Carribean, and two which had intermediate pigmentation. In the Caucasian skin samples irradiated, all were associated with the UV-induction of high molecular weight radical-adducts of DMPO, with two out of the three samples showing evidence for a low-molecular weight species previously assigned to a lipid alkoxyl radical. Thus, whilst all three Caucasian skin samples were associated with the detection of radical damage, there may be some variation in the type and extent of damage which is apparent from these initial studies.

Our study has been carried out using ex vivo skin samples after surgery, and cells within excised human skin can remain viable for up to a week after surgery. This work suggests that similar patterns of UV radiation damage to skin may be observed in vivo or in skin/organs cultured in the laboratory. All skin samples used in this study were usually used within 24 hours, and no more than 48 hours after excision. This work used non-frozen skin samples, in contrast to the frozen skin used by Jurkiewicz and Buettner, which could have caused cell rupture, and release of cell contents which may affect the photoreactivity of the excised skin tissue (particularly if sequestered metal-ions are released which exacerbate free-radical damage). Despite the use of ex vivo skin, this work clearly demonstrates that the melanin pigment in Afro-Carribean and Asian skin is protective against the UV-induced radical damage we detected in Caucasian skin, possibly due to its effective screening in both the UV and visible regions of the spectrum. Since the highly pigmented skins of Afro-Caribbeans and Asians are better protected against UV-induced skin cancers than Caucasians, our results are not inconsistent with a radical hypothesis of UV-induced skin ageing and carcinogenesis in Caucasians that are not protected by the high levels of melanin pigment found in Afro-Caribbean and Asian skin.

Afro-Caribbeans and Asians with highly pigmented skin have a lower incidence of skin cancer compared to Caucasians with less pigmentation. The damaging effects of the UV part of sunlight to the skin of Caucasians has been attributed to the production of reactive free radicals, but UV-induced free radicals have only been characterised in Caucasian and not in pigmented skin types. This work has shown that, whilst Afro-Caribbean skin was protected against the formation of the free radicals that could be detected in Caucasian skin, intermediate skin types were found variable in their responses.

The above description broadly describes the present invention without limitation. Variations and modifications as will be readily apparent to those skilled in this art are intended to be included within the scope of this application and subsequent patent(s).

1. A method for determining the presence of high molecular weight molecules in human or other mammalian skin, comprising irradiating a sample of the said skin with light at one or more wavelengths present in solar radiation, in the presence of a spin-trapping agent for radicals of said molecules, and using comparative electron spin resonance (ESR) spectroscopy to determine or investigate the presence of radicals of the said molecules induced in the skin by the light.

2. A method according to claim 1, wherein the high molecular weight molecules are proteins or protein fragments.

3. A method according to claim 2, wherein the protein is a natural skin structural protein.

4. A method according to claim 2, wherein the protein is selected from the group consisting of keratin, tropoelastin, elastin, tropocollagen and collagen.

5. A method according to claim 1, wherein the high molecular weight molecules are lipids.

6. A method according to claim 5, wherein the lipid is a natural skin phospholipid.

7. A method according to claim 1, wherein the high molecular weight molecules are polynucleotides.

8. A method according to claim 7, wherein the polynucleotide is DNA.

9. A method for determining or investigating the presence of aminoacid molecules or protein fragments in human or mammalian skin, comprising irradiating a sample of the said skin with light at one or more wavelengths present in solar radiation, in the presence of a spin-trapping agents for radicals of the said molecules, and using comparative electron spin resonance (ESR) spectroscopy to determine or investigate the presence of radicals of the said molecules induced in the skin by the light.

10. A method according to claim 9, wherein the aminoacid is a thioaminoacid.

11. A method according to claim 9, wherein the aminoacid is glutathione.

12. A method of determining whether human or other mammalian skin has suffered, or is susceptible to, structural damage, the method comprising determining or investigating the presence in the skin of high molecular weight molecules or aminoacid molecules or protein fragments, using a method according to claim 1, and correlating the levels of the said molecules in the skin with structural damage or the susceptibility thereto by means of reference data for making the correlation.

13. A method of diagnosing, and predicting a susceptibility to, skin conditions, diseases and disorders, for example skin cancers such as melanomas, the method comprising determining or investigating the presence in the skin of high molecular weight molecules or aminoacid molecules or protein fragments, using a method according to claim 1, and correlating the extent of presence of the said molecules in the skin with the presence of, or a susceptibility to, skin conditions, diseases and disorders by means of reference data for making the correlation.

14. A method of testing or evaluating the effectiveness of sunscreens and anti-ageing and other skin preparations or fabrics in reducing the exposure of skin to damage solar radiation and in reducing ageing or other structural damage to skin, the method comprising irradiating a sample of human skin or of an effective substitute therefore (herein: “skin”) shielded with the sunscreen composition or anti-ageing or other skin preparation or fabric to be tested or evaluated, with light at one or more wavelengths present in solar radiation, in the presence of a spin-trapping agent for radicals of high molecular weight molecules or aminoacid molecules or protein fragments induced in the skin by the light, and using comparative electron spin resonance (ESR) spectroscopy targeted to said molecules to test or evaluate the said effectiveness of the sunscreen composition or anti-ageing or other skin preparation or fabric.

15. A method according to claim 14, wherein the high molecular weight molecules are proteins, protein fragments, lipids or polynucleotides and the aminoacid molecule is a thioaminoacid or glutathione.

16. A method of assigning an ageing protection factor (APF) or skin damage protection factor (SDPF) to a sunscreen composition or anti-ageing or other skin preparation or fabric, comprising measuring the effectiveness of sunscreens and anti-ageing and other skin preparations or fabrics in reducing the exposure of skin to damaging solar radiation and in reducing ageing or other structural damage to skin using the method of claim 14, expressing the said effectiveness as the fraction (f) of unshielded induced radical production exhibited by the shielded skin, and assigning the APF or SDPF to the composition or preparation by virtue of the relationship:
APF or SDPF=1/f.

17. A method of assigning an ageing protection time (APT) or skin damage protection time (SDPT) to a sunscreen composition or an anti-ageing or other skin preparation or fabric by determining, using a method according to claim 12, a time taken for skin damage to the test sample exposed to the light radiation to reach a defined measurable level and assigning that time to the sunscreen composition or an anti-ageing or other skin preparation or fabric as the APT or SDPT.

18. A method according to claim 17, wherein the defined level of damage is the level representing a safe threshold level of exposure to solar radiation before unacceptable skin damage would occur.

19. A sunscreen composition or an anti-ageing or other skin preparation or fabric, to which an APF has been assigned using a method according to claim 16.

20. A sunscreen composition or anti-ageing or other skin preparation or fabric according to claim 19, which is for application to the skin at least once per day, and has an APF or SDPF which is above a determined safe minimum protection factor for the latitude, season and/or climate in which the composition or preparation is to be used, calculated having regard to the safe maximum daily exposure to solar radiation and an assumed, expected or likely actual daily exposure to solar radiation at that latitude, season and/or climate.

21. A method according to claim 14, when applied to an anti-ageing or other protective skin composition or preparation or fabric in relation to damage to skin tissue caused by exposure of skin to damaging environmental agents other than sunlight.

22. An anti-ageing or other protective skin composition or preparation or fabric, to which a protection factor (PF) or protection time (PT) has been assigned using a method according to claim 21.

23. An anti-ageing or other protective skin composition or preparation or fabric according to claim 22, which is for application to the skin at least once per day, and has an PF which is above a determined safe minimum PF for environmental agents, other than sunlight, causing oxidative stress to the skin, or a PT which is below which is above a determined safe maximum PT for environmental agents, other than sunlight, causing oxidative stress to the skin.

24. A spin-trapped polynucleotide radical, comprising an adduct of a polynucleotide radical with a spin-trapping agent therefor.

25. A spin-trapped radical according to claim 24, wherein the polynucleotide is DNA.

26. A spin-trapped radical according to claim 24, wherein the DNA is derived from a human melanoma cell.

27. A spin-trapped radical according to claim 24, which has a substantially quantitatively stable lifetime of at least about 100 s and is measurable using ESR spectroscopy.

28. A spin-trapped radical according to claim 27, wherein the quantitatively stable lifetime of the radical is at least about 1000 s.

29. A spin-trapped radical according to claim 24, wherein the spin-trapping agent is selected from the group consisting of 5,5-dimethylpyrroline-N-oxide (DMPO), 3,5-dibromo-4-nitro-benzenesulphonic acid (DBNBS), N-t.butyl-β-phenylnitrone (PBN), β-(4-pyridyl-1-oxide)-N-t.butyl-phenylnitrone (POBN), 2-methyl-2-nitrosopropane, nitrosodisulphonic acid, 3,3,5,5-tetramethyl-pyrroline N-oxide, and 2,4,6-tri-t.butylnitrosobenzene.

30. A spin-trapped skin protein radical, comprising an adduct of a skin protein radical with a spin-trapping agent therefor.

31. A spin-trapped radical according to claim 30, wherein the skin protein is a protein which occurs naturally in human skin.

32. A spin-trapped radical according to claim 31, wherein the skin protein is selected from the group consisting of keratin, tropoelastin, elastin, tropocollagen and collagen.

33. A spin-trapped radical according to claim 30, which has a substantially quantitatively stable lifetime of at least about 100 s and is measurable using ESR spectroscopy.

34. A spin-trapped radical according to claim 33, wherein the quantitatively stable lifetime of the radical is at least about 1000 s.

35. A spin-trapped radical according to claim 33, wherein the quantitatively stable lifetime of the radical is at least about 24 hours.

36. A spin-trapped radical according to claim 30, wherein the spin-trapping agent is selected from the group consisting of 5,5-dimethylpyrroline-N-oxide (DMPO), 3,5-dibromo-4-nitro-benzenesulphonic acid (DBNBS), N-t.butyl-β-phenylnitrone (PBN), β-(4-pyridyl-1-oxide)-N-t.butyl-phenylnitrone (POBN), 2-methyl-2-nitrosopropane, nitrosodisulphonic acid, 3,3,5,5-tetramethyl-pyrroline N-oxide, and 2,4,6-tri-t.butylnitrosobenzene.

37. A method of determining whether human or other mammalian skin has suffered, or is susceptible to, structural damage, the method comprising determining or investigating the presence in the skin of high molecular weight molecules or aminoacid molecules or protein fragments, using a method according to claim 9, and correlating the levels of the said molecules in the skin with structural damage or the susceptibility thereto by means of reference data for making the correlation.

38. A method of diagnosing, and predicting a susceptibility to, skin conditions, diseases and disorders, for example skin cancers such as melanomas, the method comprising determining or investigating the presence in the skin of high molecular weight molecules or aminoacid molecules or protein fragments, using a method according to claim 9, and correlating the extent of presence of the said molecules in the skin with the presence of, or a susceptibility to, skin conditions, diseases and disorders by means of reference data for making the correlation.

39. A method of assigning an ageing protection time (APT) or skin damage protection time (SDPT) to a sunscreen composition or an anti-ageing or other skin preparation or fabric by determining, using a method according to claim 37, a time taken for skin damage to the test sample exposed to the light radiation to reach a defined measurable level and assigning that time to the sunscreen composition or an anti-ageing or other skin preparation or fabric as the APT or SDPT.

40. A method according to claim 39, wherein the defined level of damage is the level representing a safe threshold level of exposure to solar radiation before unacceptable skin damage would occur.

41. A sunscreen composition or an anti-ageing or other skin preparation or fabric, to which a SDPT has been assigned using a method according to claim 17.

42. A sunscreen composition or an anti-ageing or other skin preparation or fabric, to which a SDPT has been assigned using a method according to claim 39.

43. A sunscreen composition or anti-ageing or other skin preparation or fabric according to claim 41, which is for application to the skin at least once per day, and has an APT or SDPT which is below a determined safe maximum protection time for the latitude, season and/or climate in which the composition or preparation is to be used, calculated having regard to the safe maximum daily exposure to solar radiation and an assumed, expected or likely actual daily exposure to solar radiation at that latitude, season and/or climate.

44. A sunscreen composition or anti-ageing or other skin preparation or fabric according to claim 42, which is for application to the skin at least once per day, and has an APT or SDPT which is below a determined safe maximum protection time for the latitude, season and/or climate in which the composition or preparation is to be used, calculated having regard to the safe maximum daily exposure to solar radiation and an assumed, expected or likely actual daily exposure to solar radiation at that latitude, season and/or climate.

45. A method according to claim 16, when applied to an anti-ageing or other protective skin composition or preparation or fabric in relation to damage to skin tissue caused by exposure of skin to damaging environmental agents other than sunlight.

46. A method according to claim 17, when applied to an anti-ageing or other protective skin composition or preparation or fabric in relation to damage to skin tissue caused by exposure of skin to damaging environmental agents other than sunlight.

47. A method according to claim 39, when applied to an anti-ageing or other protective skin composition or preparation or fabric in relation to damage to skin tissue caused by exposure of skin to damaging environmental agents other than sunlight.

48. An anti-ageing or other protective skin composition or preparation or fabric, to which a protection factor (PF) or protection time (PT) has been assigned using a method according to claim 45.

49. An anti-ageing or other protective skin composition or preparation or fabric, to which a protection factor (PF) or protection time (PT) has been assigned using a method according to claim 46.

50. An anti-ageing or other protective skin composition or preparation or fabric, to which a protection factor (PF) or protection time (PT) has been assigned using a method according to claim 47.

51. An anti-ageing or other protective skin composition or preparation or fabric according to claim 48, which is for application to the skin at least once per day, and has an PF which is above a determined safe minimum PF for environmental agents, other than sunlight, causing oxidative stress to the skin, or a PT which is below which is above a determined safe maximum PT for environmental agents, other than sunlight, causing oxidative stress to the skin.

52. An anti-ageing or other protective skin composition or preparation or fabric according to claim 49, which is for application to the skin at least once per day, and has an PF which is above a determined safe minimum PF for environmental agents, other than sunlight, causing oxidative stress to the skin, or a PT which is below which is above a determined safe maximum PT for environmental agents, other than sunlight, causing oxidative stress to the skin.

53. An anti-ageing or other protective skin composition or preparation or fabric according to claim 50, which is for application to the skin at least once per day, and has an PF which is above a determined safe minimum PF for environmental agents, other than sunlight, causing oxidative stress to the skin, or a PT which is below which is above a determined safe maximum PT for environmental agents, other than sunlight, causing oxidative stress to the skin.
